(19) United States
(12) Patent Application Publication
(10) Pub. No.: US 2017/0020333 A1
(43) Pub. Date: Jan. 26, 2017

(54) Semi-automated Cooking Apparatus

(71) Applicant: Garry K. Larson, Wellsville, UT (US)

(72) Inventor: Garry K. Larson, Wellsville, UT (US)

(21) Appl. No.: 15/071,563

(22) Filed: Mar. 16, 2016

Related U.S. Application Data
(60) Provisional application No. 62/133,811, filed on Mar. 16, 2015.

(51) Int. Cl. A47J 36/38; A23L 5/10; A47J 27/00

(52) U.S. Cl. CPC A47J 36/38; A47J 27/002; A23L 5/10; A23V 2002/00

(57) ABSTRACT

A cooking apparatus incorporates both methods of ambient and contact cooking in a single operation. Food is placed in a cylindrical container which is in turn placed in a cooking apparatus. The cylindrical container is continually rolled over a heat source to cook the food. One embodiment of the apparatus has both non-cooking and cooking positions available for the canister. The canister is positioned upon a rocker arm in the non-cooking position and it transitions along the rocker arm to the cooking position over the heat source as the rocker arm pivots about its vertex. The cylinder is rotated while cooking. This rotation stirs food within the canister, allowing for contact cooking, while steam is generated and the internal temperature of the canister increases for ambient cooking. When finished, the heat source is deactivated and the canister removed, possibly by rotating the rocker arm.

### CROSS-REFERENCES TO RELATED APPLICATIONS

This Application claims priority as a perfection of prior filed provisional application No. 62/133,811, filed Mar. 16, 2015, an incorporates the same by reference herein in its entirety.

### FIELD OF THE INVENTION

The present invention relates to the field of food preparation and more particularly relates to an apparatus that efficiently incorporates multiple cooking methods in a semi-automatic fashion.

### BACKGROUND OF THE INVENTION

The art of cooking food is believed to be as old as our discovery of fire. Cooking food not only kills injurious bacteria and parasites in food, but it is generally held to improve the flavor of the food. This is particularly true when different foods, including herbs and spices, are cooked together and their flavors can then meld and enhance the entire meal.

There are many different methods and a wide variety of apparatuses used to cook food. Traditional cooking utilizing a direct heat source is done with variations on two broad methods: 1) Contact cooking, wherein a cooking surface is heated by the heat source and the food is applied directly to the heated surface, or 2) Ambient cooking, wherein heat is applied to a carrier medium (such as water, oil, or air) by the heat source and the food placed in the carrier medium is cooked by the raised temperature of the cooking medium. The first method includes techniques like frying while the second method includes such techniques as boiling or baking. Some cooking techniques, like grilling, may combine elements of both methods. Stir-frying is a contact cooking technique wherein food is constantly moved over a heated surface with a consistent motion and rate of movement. Steaming is an ambient cooking technique which uses a heated water vapor as the carrier medium. The present invention is a cooking apparatus which combines techniques of contact and ambient cooking in a simultaneous and continuous process. The cooking apparatus that utilizes a cylinder with a vented lid which is designed to keep food and liquids within the cylinder while allowing some heated air and steam escape to avoid pressurizing the cylinder. Food is placed in the cylinder, a vented lid is affixed, and the cylinder is then placed in a horizontal orientation on the apparatus over a heat source, such as a fire from a burner unit, and continuously rotates the cylinder over the heat source for a prescribed amount of time. As the cylinder rotates over the heat source the food is in continuous contact with the rotating, heated surface of the canister (stir-frying), and the food is also infused with steam (steaming), and the food is further cooked by the high ambient air temperature inside the canister (a technique similar, but not identical to broiling). An alternate embodiment features a positioning arm for the canister.

The present invention represents a departure from the prior art in that the cooking apparatus combines direct and ambient cooking methods as part of a single cooking process. The present invention also departs from prior art in that it accomplishes said cooking process in a semi-automated fashion since once the canister is placed on the apparatus it is left unattended for the duration of the cooking cycle. The unattended nature of operation is especially relevant for the contact component of the cooking process since typically grilling or frying requires manual manipulation of the food during the cook cycle to ensure complete and consistent cooking of the food and to prevent charring or overcooking.

### SUMMARY OF THE INVENTION

The present invention's general purpose is to provide a new and improved cooking apparatus that is efficient, simple to operate, and combines the benefits of multiple cooking techniques in a single process.

To accomplish these objectives, a cylindrical canister is used to contain food. A vented lid is affixed to the top of the cylinder after food is placed therein. The cylinder is then rotated over a heat source to cook food contained therein by a combination of stir-frying, steaming, and air cooking in a single, continuous process. This combination has significant advantages over utilizing only one of the aforementioned techniques or over using all three techniques in separate processes. Among said advantages are greatly reduced cooking time and a thorough and consistent blending of ingredient flavors for a more pleasing taste than a single cooking technique or multiple cooking techniques applied in separate processes. An alternate embodiment of the invention features a housing with an arm which is designed to receive a cylinder into which food is placed. The arm is set to move the cylinder onto and off of an integrated heat source, such as a gas burner, for cooking purposes.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a cooking apparatus according to one embodiment of the invention.

FIG. 2 is a perspective view of the apparatus of FIG. 1, having its external shell removed.

FIG. 3 is a partially transparent side elevation of the cooking apparatus of FIG. 2.

FIG. 4 is an exploded view of the apparatus of FIG. 1.

FIG. 5 is a perspective view of a cooking apparatus according to an alternate embodiment of the invention.

FIG. 6 is a perspective view of the apparatus of FIG. 5, having its external shell removed.

FIG. 7 is an exploded view of the apparatus of FIG. 5.

FIG. 8 is a transparent elevational view of the apparatus of claim 5, in a starting position.

FIG. 9 is a transparent elevation of the apparatus of FIG. 5, with the cylinder in a transitional position.

FIG. 10 is a transparent elevation of the apparatus of FIG. 5, with the cylinder in a cooking position.

### DETAILED DESCRIPTION OF THE PREFERRED EMBODIMENT

With reference now to the drawings, the preferred embodiment of the cooking apparatus is herein described. It should be noted that the articles “a”, “an”, and “the”, as used in this specification, include plural referents unless the content clearly dictates otherwise.

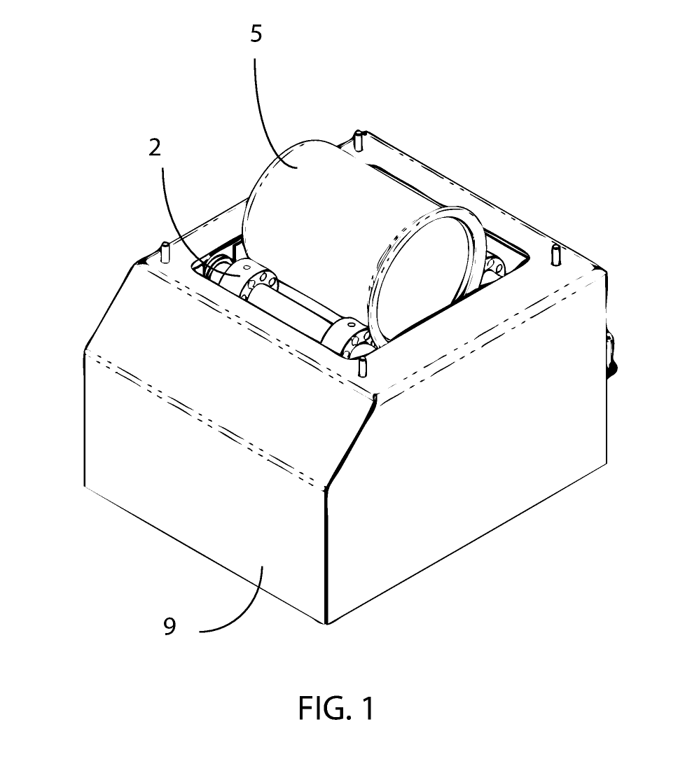

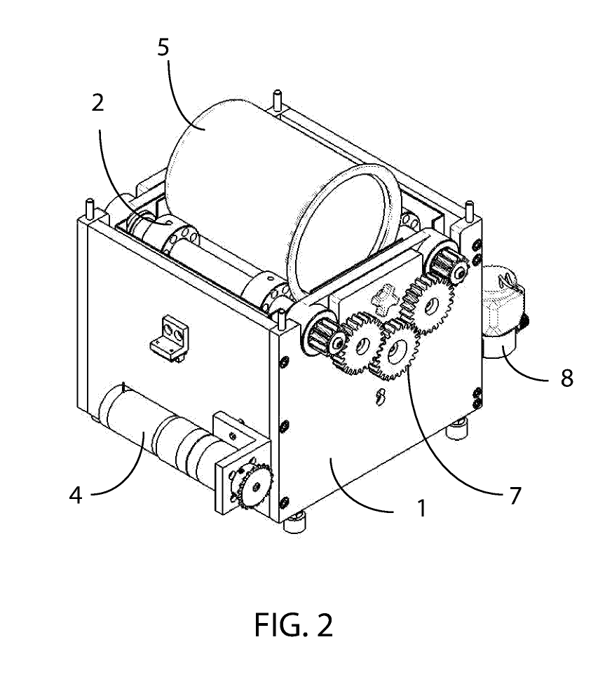

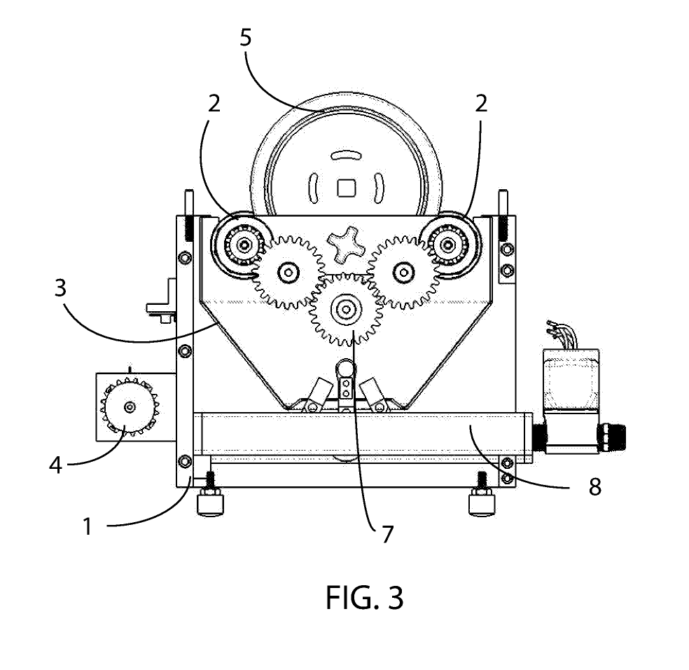

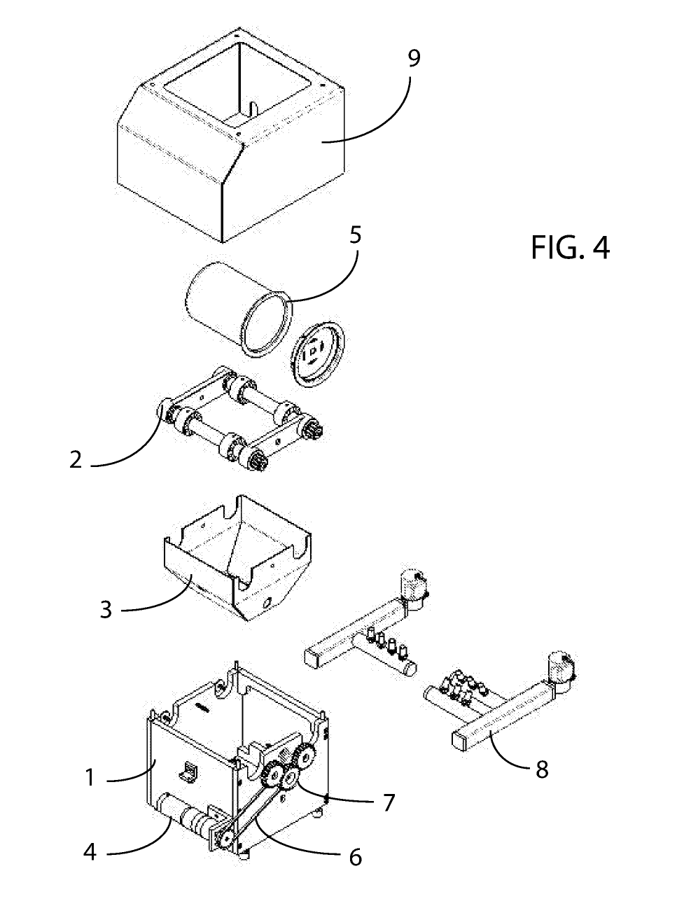

A first embodiment of a cooking apparatus is shown in FIGS. 1-4. The cooking apparatus is enclosed in a housing 9 which may provide access and mounting for control switches and status displays. Inside the housing 9 is a chassis 1 which supports the working components of the apparatus (FIGS. 2-4). A vented food canister 5 is positioned on a cradle 2 with two rotating supports over a burner 8. Heat shield 3 focuses heat from the burner 8 onto the canister 5 and protects internal components of the apparatus. The rotating supports are driven by a motor 4 connected to a gear assembly 7 by means of a chain 6 or other type of connector. It should be readily understood that the illustrated embodiment is exemplary. Any suitable burner or other heat source (including microwave or IR radiation) may be utilized as a heat source. Likewise, any means of rotating the canister may be utilized.

In use, the vented food canister 5 is prepared, usually by the addition of cooking oil or some other contact enhancing substance, and loaded with the food desired to be cooked. It is then sealed and placed on the cradle 2, shown in shown in FIG. 1. Upon activation, burner 8 is lit and motor 4 drives the cradle 2 through the gear assembly 7. In this manner, food inside the canister 5 is cooked as it is subjected to steam and heated air in the canister environment and as it rolls about inside on the hot internal surface of the food canister 5. The continued rolling of the food canister 5 continually rolls and stirs the food inside. After a set amount of time has elapsed, canister 5 is removed from cradle 2. The burner 8 is simultaneously or previously extinguished by electronic control to provide for additional safety when extracting the canister 5 and to avoid running the burner 8 unnecessarily. Burner 8 may be previously turned off and the canister 5 may still be rotated for a certain period of time to allow for cooling of the canister and its contents.

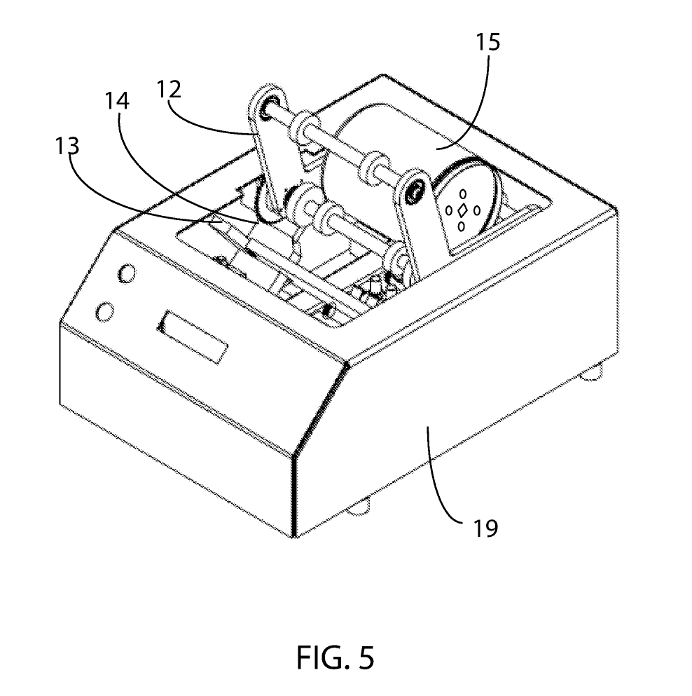

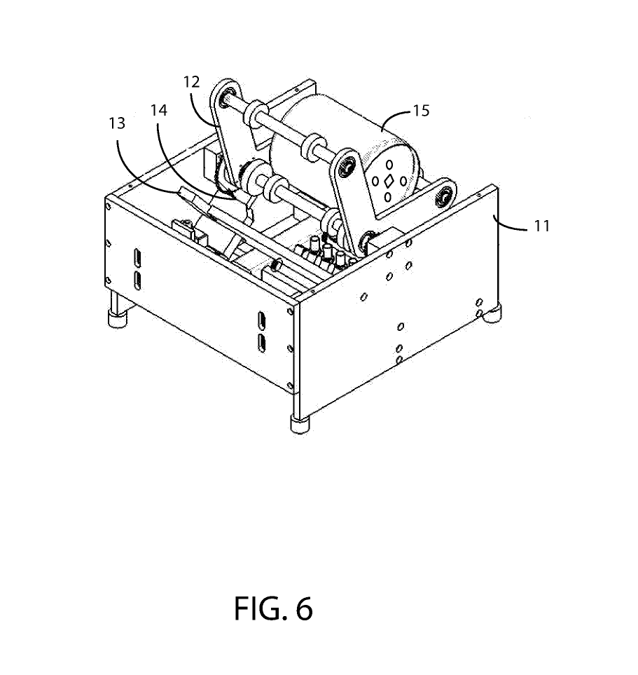

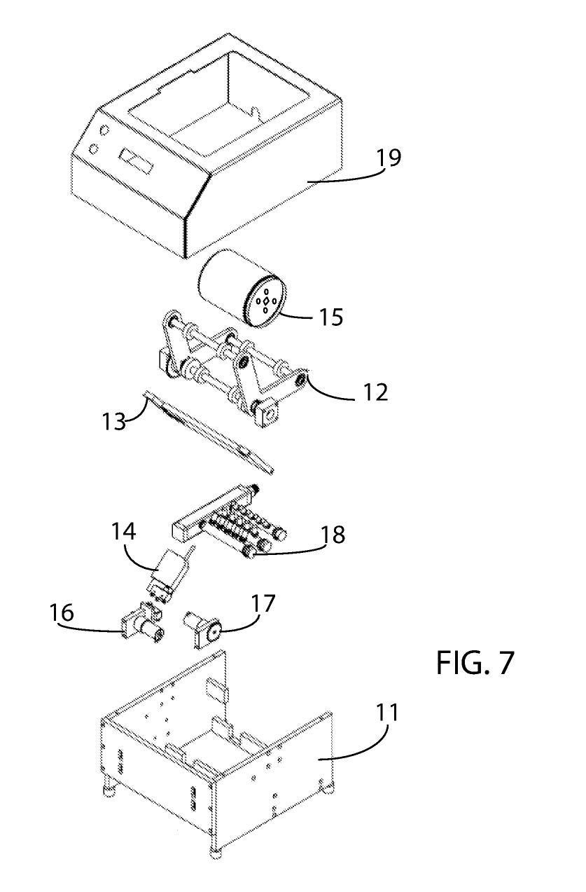

With reference to FIG. 5, another embodiment of the cooking apparatus is depicted. Like the initial embodiment, the second apparatus is enclosed in a housing 19 which may provide access and mounting for control switches and status displays. Inside the housing 19 is a chassis 11 which supports the working components of the apparatus (FIGS. 6 and 7). The most notable feature of the apparatus is the rocker arm 12. Rocker arm 12 is a bent arm with two legs at an obtuse angle to one another. It is formed by two angled brackets, between which are two end rods and a center vertex rod, situated between the brackets at their matched angle. It is pivotably mounted at the vertex of the angle formed by the two legs. The entire rocker arm assembly also features gears and supports to enable the rocker arm to move between off-burner and in-use (cook side or on-burner) positions. Its motion is controlled by a rocker motor assembly 16, mounted forward of the rocker arm 12 on the chassis 11. Rocker motor assembly 16 and rocker arm 12 are in operable contact, though this is not shown for simplicity. A roller control motor 17 is also present to rotate cylindrical food canister 15 when it is in a cooking position over burner assembly 18. It is also forwardly mounted so that it and rocker motor assembly 16 are protected by heat shield 13 when the burner assembly 18 is activated.

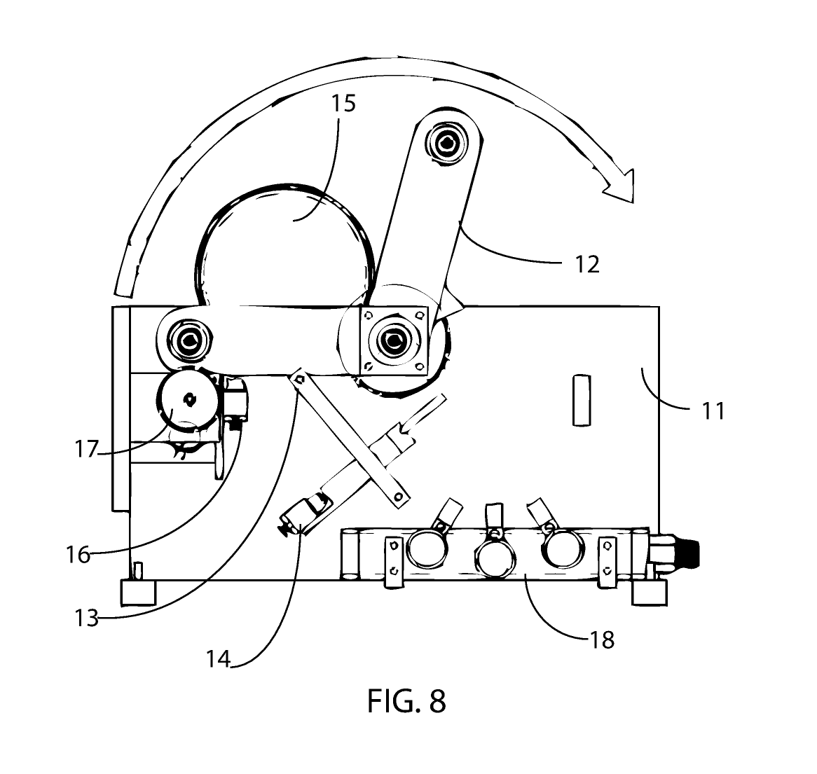

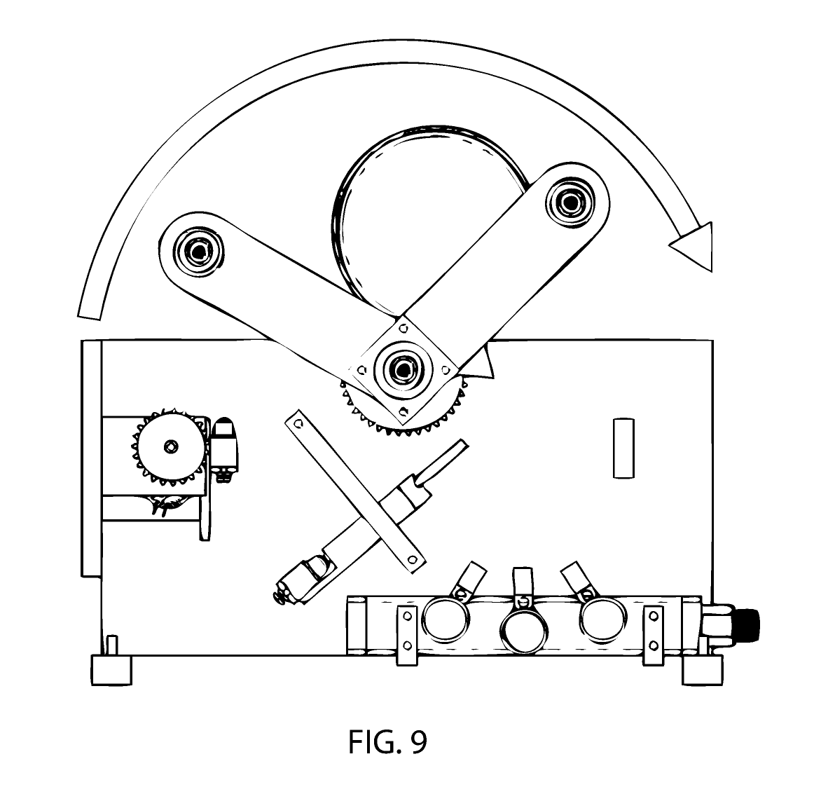

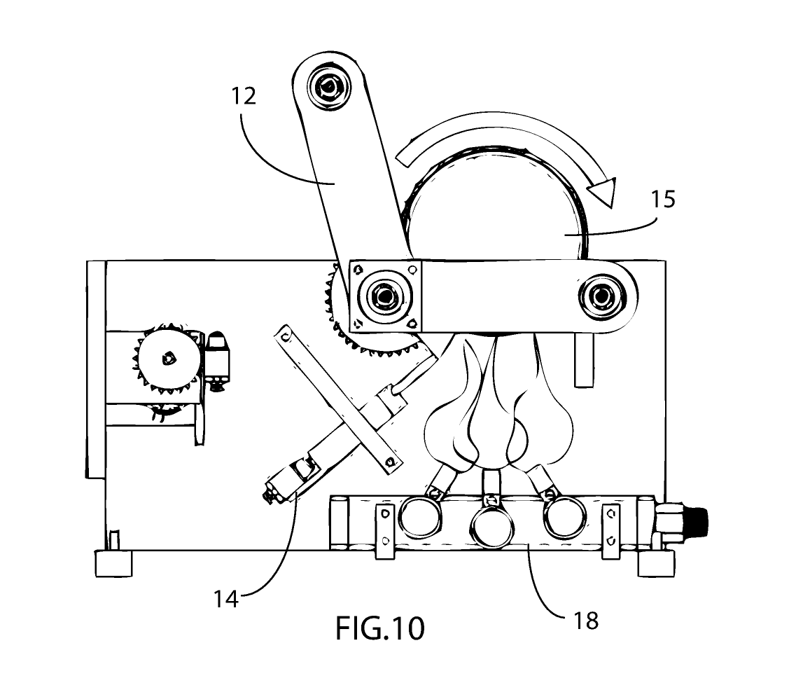

In use, the vented food canister 15 is prepared, as described above, and loaded with the food desired to be cooked. It is then sealed and placed on the rocker arm 12, shown in FIG. 8. In its initial position, the rocker arm 12 receives the food canister 15 between the two brackets and is supported by one of the end rods and the vertex rod. Upon activation, the rocker arm swings towards the burner, shown in FIG. 9. The canister 15 rolls over the vertex rod and eventually nests between the vertex rod and the other end rod, using the two brackets as a guiding track. Once in the in-use position, a spur on the rocker arm 12 contacts a limit switch 14 extending to the cook side of the assembly. This contact activates the switch and stops motion of the rocker arm 12 while activating the roller motor 17 and burner assembly 18. The roller motor 17 is operatively connected to the rocker arm 12 in a manner to rotate the food canister 15 (FIG. 10). In this manner, food inside the canister 15 is cooked as described above. After a set amount of time has elapsed, the process is reversed and the rocker arm returns the canister 15 to the off-burner position for extraction therefrom. The burner 18 is simultaneously extinguished by electronic control to provide for additional safety when extracting the canister 15 and to avoid running the burner 18 unnecessarily. In the off-burner position, the canister 15 may also still be rotated for a certain period of time to allow for cooling of the canister and its contents. The rocker arm assembly 12 is placed in such a way that its operation and the rotation of the canister 15 may be easily observed by either an operator or customer while the burner assembly is shielded for safety purposes.

Various enhancements may be further added to the apparatus. A locking mechanism may be added to the canister to avoid ejection of the lid in the event the lid vents become obstructed and pressure builds up in the canister. Various controls and displays may be added to allow for additional functionality and control in the preparation and cooking process.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A cooking apparatus comprising:
a. a vented cylindrical canister for food containment;
b. a containment structure, said containment structure further comprising:
i. a chassis defining an interior;
ii. a heat source; and
iii. a heat shield; and
c. a rolling cradle with drive assembly, the cradle located over the heat source
wherein the vented cylindrical canister is placed on the rolling cradle, over the heat source, and rotated in a manner that food placed in the vented cylindrical canister continually rolls over the heat source until cooking is accomplished.

2. The cooking apparatus of claim 1, further comprising:
a. the interior of the chassis divided into a cook side and a non-cook side;
b. the heat source directed towards the cook side of the interior;
c. the heat shield separating the heat source from the non-cook side of the interior;
d. the cradle being a part of a rocker arm further comprising:
i. two brackets each having two legs set at an obtuse angle in relation to each other;
ii. a vertex support rod extending between the two brackets at a vertex of the brackets;
iii. a plurality of side support arms, equidistantly positioned form the vertex support rod; and
iv. when assembled the rocker arm has two legs obtusely related to each other;
wherein the rocker arm is positioned on an upper portion of the containment structure, such that the vertex is centrally located and divides the interior between its cook side and non-cook side and will rotate in a manner that in a cooking position one leg of the rocker arm serves as the cradle and is directly positioned over the cook side while in a non-cooking position the other leg is so oriented over the non-cook side, the canister being received in the non-cook side and rolled onto the cradle when the rocker arm rotates to cook and reversed when cooking is completed.

3. A method of cooking, the method comprising:
a. placing food in a vented cylindrical canister;
b. positioning the vented cylindrical canister over a heat source;
c. continuously rolling the venter cylindrical canister over the heat source until the food is cooked;
d. removing the vented cylindrical canister from the heat source and removing the food from therein.

4. The method of claim 3, the method further comprising placing the vented cylindrical canister in a cradle which continually rolls the canister over the heat source.

5. The method of claim 3, the method further comprising placing the vented cylindrical canister in a rocker arm which alternately holds the canister in a non-cooking location and a cooking location, over the heat source, the canister being rolled from one to the other and being continuously rolled in the rocker arm when in the cooking location.
